(19) United States
(12) Patent Application Publication
(10) Pub. No.: US 2003/0215655 A1
(43) Pub. Date: Nov. 20, 2003

(54) Polyester compositions for multilayer extrusion and barrier performance

(76) Inventors: Mark A. Barger, Midland, MI (US); Joseph A. Schomaker, Mt. Pleasant, MI (US); Ravi Ramanathan, Midland, MI (US); Malcolm F. Finlayson, Houston, TX (US); Chuiwah A. Cheung, Lake Jackson, TX (US); Kalyan Sehanobish, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/275,135

(22) PCT Filed: May 11, 2001
(86) PCT No.: PCT/US01/15431

(51) Int. Cl. B32B 27/06

(52) U.S. Cl. 428/483; 428/500

(57) ABSTRACT

Improved multi-layer coextruded blow-molded objects (such as fuel containers) having at least a barrier layer and a support layer are disclosed together with improved methods for preparing such objects. The barrier layer includes an amount of modified polyolefin having approximately the same density as the support layer, wherein the modified polyolefin is prepared by grafting an unsaturated carboxylic acid or a derivative thereof to the polyolefin, the modified polyolefin being added in an amount such that the gas-barrier layer sufficiently adheres to the adjacent layer and such that the gas barrier properties of the fabricated article are still adequate. The present invention also relates to modification of the rheology of base resins, such as PET (a preferred material for the barrier layer), so that they more closely match the rheology of high density polyethylene (a preferred material for the support layer).

### FIELD OF THE INVENTION

The present invention relates to improving the adhesion between a barrier layer and a support layer in coextruded blow-molded applications. More particularly this invention relates to the incorporation of a modified polyethylene having adhesive properties into either the barrier layer or the support layer, wherein the modified polyethylene is prepared by grafting an unsaturated carboxylic acid or derivative thereof to high-density polyethylene. Furthermore, the present invention also relates to modification of the rheology of base resins, such as PET, so that they more closely match the rheology of high density polyethylene (a preferred material for the support layer in the coextruded blow-molded applications). A better match in rheological properties facilitates layer uniformity within a parison, resulting in more consistent final products.

### BACKGROUND AND SUMMARY OF THE INVENTION

Plastics (synthetic resins) have long been used for various container applications due to their light weight, ready availability, relatively low cost to produce and high strength.

Polyolefin resins have proven particularly useful for such applications. While polyolefin resins possess many desired properties, they are not particularly effective as a barrier to gases or vapors of chemicals such as hydrocarbons, alcohols, ketones, ethers, etc. Thus, polyolefin resins by themselves are not suitable for many applications where containment of chemical vapors is critical for environmental or safety reasons. These applications include fabricated articles such as storage or transportation containers or vessels, for example, fuel tanks, conduits or membranes.

Accordingly, efforts have been made to improve the barrier performance of containers made from polyolefins. One such effort is U.S. Pat. No. 5,441,781 which teaches a multilayer container (fuel tank), such that one layer will provide the gas barrier properties while another (polyolefin) layer will provide the support. This reference teaches that a third layer (an “adhesive layer”) must be used so that the barrier layer will adhere to the support layer. The reference teaches that the adhesive layer comprises a resin such as a modified polyethylene prepared by grafting an unsaturated carboxylic acid or a derivative thereof to high-density polyethylene (HDPE).

It would be desirable to be able to eliminate this adhesive layer to simplify manufacturing and reduce cost, yet still have a Polyolefin-based container with adequate gas-barrier properties.

It has now surprisingly been discovered that when low levels of certain adhesive materials such as those taught in the '781 patent, are incorporated within a resin (such as polyethylene terephthalate, PET) exhibiting permeation barrier properties to fuel components, and, in particular, exhibiting permeation barrier to oxygenated fuel components such as methanol and ethanol, then the adherence properties of the resin are improved, while maintaining the gas-barrier performance Thus, one aspect of the invention is an improved resin comprising polyethylene terephthalate and High Density polyethylene modified with maleic anhydride (HDPE-g-MAH), wherein the polyethylene terephthalate comprises 90 to 98 percent of the composition, the modified polyethylene comprises 10 to 2 percent of the composition, and the maleic anhydride comprises from 0.5 to 5.0% percent by weight of the modified polyethylene.

It has also been discovered that when certain other adhesive materials (for example, LLDPE-g-MAH) are added to the PET at the same concentrations as the aforementioned HDPE-g-MAH, the barrier performance of the blend is diminished. Thus, while it is possible to achieve adhesion between PET and HDPE merely by blending in a material that is chemically compatible with each phase, the present invention is unique in that adhesion can be achieved without diminishing the barrier performance of the barrier.

This new resin can be advantageously used in multilayer structures as it will allow the elimination of adhesive or tie layers. Barrier layers comprised of the resin of the invention will adhere much better to other layers, including polyolefinic support layers, eliminating the necessity of an adhesive or tie layer. Thus rather than the 3 or 5 layer structures taught by the '781 patent the resin of the current invention allows 2 or three layer structures. Furthermore, even if a tie layer is still used, adhesion between PET and a tie layer will be improved if the PET is first modified by the incorporation of high density polyethylene-grafted-maleic anhydride.

Accordingly, another aspect of the invention is a multilayer plastic container comprising two layers, one of which is a gas-barrier layer, the other of which is a polyolefinic support layer, wherein the barrier layer includes an amount of modified high-density polyethylene, wherein the modified high-density polyethylene is prepared by grafting an unsaturated carboxylic acid or a derivative thereof to the high-density polyethylene, the modified high-density polyethylene being added in an amount such that the gas-barrier layer sufficiently adheres to the adjacent layer.

It would also be valuable to improve the adherence properties of PET in general, so that PET may also be more easily used in applications other than containers. Thus, another aspect of the invention comprises a method of improving the adherence properties of the barrier layer (which can be crystalline polyesters, crystalline polyamides, crystalline polyarylates and crystalline poly(ethylene-co-vinyl alcohol) resins) to polyolefinic materials comprising incorporating a modified polyethylene prepared by grafting an unsaturated carboxylic acid or a derivative thereof to the polyethylene, wherein the modified polyethylene is added to the polyethylene terephthalate in an amount between 2% and 10% percent by weight, preferably in an amount between 3% and 8% by weight. In the case of fuel tank applications, the polyethylene material is preferably high density polyethylene and the modified polyethylene is a modified high density polyethylene.

Currently, coextrusion blow-molding is the preferred method of manufacture for multilayered fabricated articles. This method requires a sufficient rheological match between the constituent materials in order to promote adequate layer uniformity within the annular parison dye. Conventional PET, as well as other conventional polyesters, such as poly(butylene terephthalate), poly (ethylene naphthalate), polylactic acid, polyester copolymers containing the terephthalate moiety, and liquid crystalline polyarylates, exhibits fairly newtonian behavior in the melt whereas HDPE resins behave decidedly non-newtonianly. Thus, combinations of PET and HDPE have heretofore resulted in coextruded sheets and blow-molded articles having marginal to poor layer uniformity. Accordingly, yet another aspect of the present invention addresses this problem by increasing the long chain branching in the polyesters, without the formation of significant crosslinking or gels.

### DETAILED DESCRIPTION OF THE INVENTION

The improved barrier resin of the present invention comprises a base resin which can be crystalline polyesters, crystalline polyamides, crystalline polyarylates or crystalline poly(ethylene-co-vinyl alcohol) resins together with a minor amount of a modified high-density polyethylene (HDPE). Preferably, the HDPE is modified with unsaturated carboxylic acid or derivative thereof, such as maleic anhydride, acrylic acid etc. The improved barrier resin comprises 90 to 98 percent of the base resin, and 10 to 2 percent of the modified polyethylene. The modified polyethylene comprises from 0.5 to 5.0 percent by weight (preferably 0.5 to 1.4 percent) of the unsaturated carboxylic acid or derivative.

The resin of the present invention exhibits improved adherence as compared to unmodified PET, while maintaining its barrier properties. Thus, the resin of the present invention can be advantageously used in multilayer plastic container having at least two layers, one of which is a gas-barrier layer, the other of which is a polyolefinic support layer. Such containers are described in U.S. Pat. No. 5,441,781. Suitable polyolefinic materials are described U.S. Pat. No. 5,380,810, U.S. patent application Ser. No. 08/857,817, or U.S. patent application Ser. No. 08/857,816. The preferred material to be used in the support layer is HDPE. Should the melt strength need to be improved (for example when preparing heavy items such as automobile fuel tanks) then methods such as those described in WO 99/10393; WO 99/10415; WO 99/10421; WO 99/10422; WO 99/10423; WO 99/10424; WO 99/10425; WO 99/10426 or WO 99/10427 can be used to modify these polyolefinic materials in order to give them greater melt strength.

The containers of the present invention can consist of only two layers, but additional layers may advantageously be used. For example, it may be desired that two support layers surround the barrier layer such that the support layers are in contact both with the contents of the container and the outside environment to which the container is exposed.

Furthermore, while the improved adherence of the resins of the present invention allow tie-layers to be eliminated in most cases, in certain applications, superior adherence between the layers may be desired, in which case the use of a tie layer may still be preferred. It should be appreciated that just as the resins of the present invention improve the adherence of the barrier layer to a support layer, it will also improve the adherence of the barrier layer to a tie layer. Preferred tie layers to be used in the present invention include those described in the '781 patent.

The multilayer containers, which are an example of the present invention, may be produced by any means known in the art. This includes blow molding as well as coextruding sheets followed by thermoforming with or without welding of the two or more parts to form the containers. Blow molding methods, are generally preferred. For example, resins for each layer can be separately plasticized in two or more extruders, introduced into the same die, laminated in the die while leveling each thickness to prepare a parison having the appearance of being one-layered. The parison can then be inflated in a mold by application of inner pressure of air so that the parison is brought into contact with the mold and cooled.

In coextrusion blowmolding, it is advantageous that the various layers have similar rheological properties. To this end, it has been discovered that by increasing long chain branching within polyester material used as the base barrier material, typical polyesters will have rheology which is more similar to HDPE. This is advantageous whether or not the barrier material includes the modified polyolefin to improve the adhesiveness. Base polyesters which can be altered in this way include PET, poly (butylene terephthalate), poly (ethylene naphthalate), polylactic acid, polyester copolymers containing the terephthalate moiety, and liquid crystalline polyarylates.

Long chain branching can be promoted by incorporating multifunctional monomers within the initial polymerization, or by post reactor modification such as reactive extrusion with a multi-functional branching agent. These processes are generally known in the art (see for example, U.S. Pat. No. 5,536,793; U.S. Pat. No. 5,556,926; U.S. Pat. No. 5,422,381; U.S. Pat. No. 5,362,763, and U.S. Pat. No. 5,422,381). Potential branching agents known in the art include trimellitic anhydride, trimesic anhydride, phthalic anhydride, pyromellitic dianhydride (PMDA) and any monomers containing 3 or more hydroxyl groups. Reactive extrusion using PMDA is a preferred method of promoting long chain branches. The branching agent should be added at a level to avoid significant cross linking and/or gel formation. Less than 1% by weight of the branching agent is preferred.

Optionally, additives which are good nucleating agents may be used to promote the crystallization of the branched polyester, to help compensate for the fact that crystallization of branched materials are generally less thermodynamically favored compared to linear materials.

Suitable nucleating agents are well known in the art (see, for example, US-A4,572,852; U.S. Pat. No. 5,431,972; U.S. Pat. No. 5,843,545; or U.S. Pat. No. 5,747,127).

Thus, a particularly favored embodiment of the present invention comprises a multilayered article comprising at least a barrier layer and a support layer. The support layer is preferably HDPE, and the barrier layer comprises polyethylene terephthalate with long chain branching with a relatively small amount of HDPE to which a small amount of maleic anhydride has been grafted. The article in this particularly favored embodiment is prepared by coextrusion blow molding. Such an article would be especially well suited for use as a fuel tank compatible for use with oxygenated fuels.

Further, it has been discovered that the barrier properties of the barrier layer are largely dependent upon the percent crystallinity (X_{c}) of the polymer which makes up the barrier layer. When using PET as the barrier layer, it is preferred that the polymer in the finished container exhibit greater than 8 percent, more preferably 21 percent and most preferably 34 percent crystallinity, and preferably no more than 50 percent, more preferably no more than 40% as measured by Differential Scanning Calorimetry. It is expected that other barrier resins will exhibit similar relationship between barrier properties and amount of crystallinity. Crystallinity of these barrier resins can be altered by those means known in the art, such as controlling the cooling rate and or annealing.

It should be understood that crystallinity can be affected by certain fuel components, such as methanol. Methanol is known to disrupt hydrogen bonding of EVOH and thereby reduce the barrier performance of EVOH. In the case of PET, however, we have discovered, that methanol can cause solvent-induced crystallization which raises the level of crystallinity and therefore further improves the barrier performance. The hydrogen bonding in EVOH is also known to be disrupted by moisture, whereas the barrier performance of PET is not effected by moisture. This has particular consequences in the overall construction and design of multilayer fuel container structures. EVOH should be precluded from being in direct contact with a fuel layer which contains moisture or methanol. PET, on the other hand, does not exhibit the same drawbacks, and can be in direct contact with the fuel.

It is also generally known that in addition to the amount of crystallinity, the morphology of the crystals is another factor in improving the barrier resistance properties of the resin, but this effect is minor in comparison to effect related to the level of crystallinity.

### EXAMPLES

In the Examples the following terms shall have the indicated meanings:

“PET1” is conventional PET (Lighterm L90A from The Dow Chemical Company), having an inherent viscosity of 0.77, determined at 0.5% concentration (w/v) and 23° C. in phenol/1,2-dichlolobenzene solution (60/40 by weight).

“PET2” is a modified PET prepared by reactively extruding PET1 with 0.45% by weight pyromellitic dianhydride (PMDA), followed by solid state advancement for 14 hours at a temperature of 196° C. GPC-DV was used to analyze the resulting polymer and it was determined that PET2 exhibited an increase in weight average molecular weight (from 46 to 135 kg/mol), a broader polydispersity index (from 1.9 to 5.3) as compared to PET 1. PET2 had an inherent viscosity of 2.28, determined at 0.5% concentration (w/v) and 23° C. in phenol/1,2-dichlolobenzene solution (60/40 by weight). “PET3” is a nucleated PET (Versatray™ 12822 from Eastman Chemical Company), having an inherent viscosity of 0.89, determined at 0.5% concentration (w/v) and 23° C. in phenol/tetrachloroethane solution (60/40 by weight).

### Examples 1-4

The following examples were prepared to demonstrate the improved cohesiveness of multilayer articles where the barrier layer includes a modified polyolefin according to the present invention. The multilayer bottles were prepared on a Bekum BM-502 Blow Molding machine, running at a production rate of approximately 42 pounds per hour. Bottle weight was approximately 60 g (total shot weight 85-90 g). The PET barrier layer was the inner layer, and in all cases exhibited a melt temperature of approximately 254° C. The support layer in each case was HDPE (Lupolen™ 4261A HDPE obtained from BASF). The tie layer if present was ADMER™ SF-700, an EVA base adhesive obtained from Mitsui Petrochemicals.

The results of these evaluations are shown in table I.

TABLE I

| EXAMPLE | BARRIER LAYER | TIE LAYER | RESULT |
|---|---|---|---|
| 1 | PET1 | yes | Good adhesion |
| 2 | PET2 | yes | Better adhesion than in |
| | | | Example 1 |
| 3 | PET1 | None | Delamination within |
| | | | an hour |
| 4 | PET2 | None | No delamination even |
| | | | after 2 weeks |

### Examples 5-8

The following examples were prepared to demonstrate the improved processing characteristics obtained by using a polyester material having long chain branching wherein the amount of long chain branching in the polyester material is selected such that the rheology of the polyester material more closely matches the rheology of a support layer, according to the present invention.

The melt viscosity of HDPE (Lupolen™ 4261A HDPE obtained from BASF), PET1, PET2 and PET3 were then characterized using a Rheometrics RMS800 equipped with a parallel plate fixture and configured to operate in the linear viscoelastic regime. The data is reproduced in FIG. 1 and indicates that PET2, exhibits similar rheology to HDPE, and substantially different than PET1 or PET3.

[image]

### Examples 9-13

### Permeation Testing

The permeability of Fuel CM15 through free standing films of the barrier materials is measured at 41° C. (+/−1° C.) using the following procedure. A test film, 4 inch diameter disk with a thickness between 1 and 100 mil, is mounted between the two chambers of the test cell. Fuel CM15 (mixture comprising 42.5/42.5/15 volume % of toluene/isooctane/methanol, 95 mL) is added to the upper chamber, layering on top of the test specimen film, and helium flowing at 10 mL/min is passed through the lower chamber. As fuel permeates through the barrier film into the lower chamber, it is swept in a helium stream from the test cell and through an injector loop of a gas chromatograph (GC). At a specific time interval, the contents of the injector loop are injected onto the front end of a 25 m, 0.53 mm ID, Chrompack Poraplot-U capillary column operating at 140° C. using a helium flow of 10 mL/min as the carrier gas. The GC separates, identifies by retention time, and quantifies the fuel components which have permeated through the specimen film. The date and time of the injection, permeant identities and peak raw area counts of the permeated components are stored in a computer file for further analysis. Using a multiport valve, 16 helium sample streams are monitored by the GC; each stream is tested for fuel component content at an eight-hour interval. Fifteen of the 16 sample streams are connected to specimen film permeation cells.

The sixteenth stream is from a gas cylinder containing a reference mixture of 50 ppm each of toluene, isooctane, and methanol, with a make up of helium. The reference gas data is used to calibrate the GC raw area counts data to determine the ppm levels of the fuel components in the sample streams from the permeation cells.

The specimen test films were prepared by compression molding using a 6 inch by 6 inch by 5 mil thick mold in a Pasadena Hydraulics, Inc. Press. The EVOH material was Eval™ F101A, with 32 mol percent ethylene. The EVOH was compression molded using the following conditions: 1) melt resin in the mold for 4 minutes at 1000 pounds applied pressure at 210° C.; 2) press resin for 6 minutes at 40,000 pounds applied pressure at 210° C.; and 3) cool the mold slowly, over one hour, to 50° C. under 40,000 pounds applied pressure. The PET resins were molded under similar conditions except that in step 1, the mold was heated to 280° C.

Fuel barrier properties were measured on thin film specimen of several materials.

These evaluations produced the following results, as shown in Table II.

TABLE II

| | Permeability, (g*mil/m²*day), @ 41° C. | | |
|---|---|---|---|
| Material | 400 Hours | 900 Hours | 3500 Hours |
| EVOH | 50 | | |
| PET3 | | 4† | |
| PET1 | | 7† | 15 |
| PET2 | | 3† | 10 |

†The permeation was not yet at steady state when this measurement was taken, the permeation was still slowly increasing.

As shown in Table II, the EVOH reached steady state permeation in 400 hours and the experiment was stopped. At 900 hours the permeations associated with the 3 PET samples had not yet reached steady state, though the permeations were all roughly an order of magnitude lower than the steady state permeation of EVOH. The permeation experiment for PET3 was discontinued at this time. The permeations in PET1 and PET2 came to steady state after 3500 hours. Contrary to expectations, the PET2 material has lower permeability than PET 1. PET2, being long-chain branched, was not expected to crystallize as efficiently as PET1. It is believed, though, that the branching in PET2 performs like a homogeneous site of nucleation, similar to the heterogeneous nucleation in PET3, as shown in the 900 hour permeation data.

### Examples 14-17

The effect of the level of crystallinity on the fuel barrier properties of PET were evaluated according to the following procedure. Samples of PET2 were prepared having varying levels of crystallinity (X_{c}). Examples 14-16 were prepared by melt, quench and then annealing the material at 130° C. for 10, 20 or 30 seconds, respectively. Example 17 was prepared by melt followed by a slow cool. The crystallinity levels were estimated using DSC. Permeability measurements were then conducted as in the Examples 9-13, and the permeability rates after 350 hours are reported in Table III:

TABLE III

| | | Permeability rate after 350 hours |
|---|---|---|
| Sample | X_{c} | (g*mil)/m²*day) |
| 14 | 2 | unmeasurably high |
| 15 | 8 | 12 |
| 16 | 21 | 6 |
| 17 | 34 | 4 |

1. A multilayer plastic fabricated article comprising at least two layers, one of which is a gas-barrier layer, the other of which is a polyolefinic support layer, wherein the barrier layer includes an amount of modified polyolefin having approximately the same density as the support layer, wherein the modified polyolefin is prepared by grafting an unsaturated carboxylic acid or a derivative thereof to the polyolefin, the modified polyolefin being added in an amount such that the gas-barrier layer sufficiently adheres to the adjacent layer and such that the gas barrier properties of the fabricated article are not diminished in comparison with the barrier properties of a fabricated article wherein the barrier layer does not include an amount of modified polyolefin.

2. A fabricated article as in claim 1, wherein the barrier layer is crystalline polyesters, crystalline polyamides, crystalline polyarylates or crystalline poly(ethylene-co-vinyl alcohol) resins.

3. A fabricated article as in claim 2, wherein the barrier layer comprises homopolymers or copolymers of polyethylene terephthalate.

4. A fabricated article as in claim 1 wherein the modified polyolefin is modified high-density polyethylene.

5. A fabricated article as in claim 1 wherein the modified polyolefin contains from 0.5 to 5.0 percent by weight of the carboxylic acid or derivative.

6. A fabricated article as in claim 1 wherein the modified polyolefin contains from 0.8 to 1.2 percent by weight of the carboxylic acid or derivative.

7. A fabricated article as in claim 1 wherein the carboxylic acid derivative is maleic anhydride.

8. A fabricated article as in claim 1 wherein the modified polyolefin is present in the barrier layer in an amount of from 2 to 10 percent by weight of the barrier layer.

9. A fabricated article as in claim 1 wherein the barrier layer adheres directly to the polyolefinic support layer.

10. A fabricated article as in claim 1 wherein the article is a container, a conduit or a membrane.

11. A fabricated article as in claim 1 wherein the polyolefinic support layer is high density polyethylene.

12. A fabricated article as in claim 3 wherein the modified polyethylene terephthalate has been Theologically altered for optimal coextrusion with the polyolefinic layer.

13. A fabricated article as in claim 12 wherein the polyethylene terephthalate has been Theologically altered through branching.

14. A fabricated article as in claim 1 wherein the barrier layer has a level of crystallinity of at least 21 percent.

15. A fabricated article as in claim 14 wherein the barrier layer has a level of crystallinity of at least 34 percent.

16. A fabricated article as in claim 1 wherein the fabricated article is made by blow molding, thermoforming, twin sheet forming or multi-component injection molding.

17. A method of improving the adherence properties of polyesters to polyolefinic materials comprising incorporating a modified high density polyethylene prepared by grafting an unsaturated carboxylic acid or a derivative thereof to the high-density polyethylene, wherein the modified high density polyethylene is added to the polyethylene terephthalate in an amount between 2 and 10 percent by weight of the polyester.

18. The method of claim 17 wherein the polyester is polyethylene terephthalate, and the unsaturated carboxylic acid or a derivative thereof is maleic anhydride.

19. An improved resin comprising polyethylene terephthalate and polyethylene modified with maleic anhydride, wherein the polyethylene terephthalate comprises 90 to 98 percent of the composition, the modified polyethylene comprises 10 to 2 percent of the composition, and the maleic anhydride comprises from 0.5 to 5.0 percent by weight of the modified polyethylene.

20. An improved coextruded multilayered article comprising a polyester material having long chain branching and a support layer comprising high density polyethylene, wherein the amount of long chain branching in the polyester material is selected such that the rheology of the polyester material more closely matches the rheology of the support layer.

21. A process for improving the processibility of a blow molded article having two or more polymeric layers comprising:
adjusting the rheology of one of the layers by promoting long chain branching such that the rheology of the adjusted layer more closely matches the rheology of the non-adjusted layer.

22. The process of claim 21 wherein the long chain branching is adjusted by incorporating multifunctional monomers

23. The process of claim 21 wherein the long chain branching is adjusted by reactive extrusion with a multi-functional branching agent.
